(19) United States
(12) Patent Application Publication
(10) Pub. No.: US 2007/0081752 A1
(43) Pub. Date: Apr. 12, 2007

(54) Bearing apparatus for a wheel of vehicle

(75) Inventors: Kouji Kametaka, Shizuoka-ken (JP); Hisashi Ohtsuki, Shizuoka-ken (JP)

Correspondence Address: HARNESS, DICKEY & PIERCE, P.L.C., P.O. BOX 828, BLOOMFIELD HILLS, MI, 48303, US

(73) Assignee: NTN Corporation, Osaka (JP)

(21) Appl. No.: 10/578,420

(22) PCT Filed: Oct. 26, 2004
(86) PCT No.: PCT/JP04/15843

§ 371 Date: May 5, 2006

(30) Foreign Application Priority Data
Nov. 5, 2003 (JP) 2003-375104

(51) Int. Cl. F16C 13/00

(52) U.S. Cl. 384/544

(57) ABSTRACT

A bearing apparatus for a wheel of a vehicle for rotatably supporting a wheel of a vehicle relative to a suspension system. The bearing apparatus improves the durability of an inner ring fit onto a wheel hub. The bearing apparatus for a wheel of a vehicle has an inner member which includes a wheel hub with an integrally formed wheel mounting flange at one end a cylindrical portion axially extending from the wheel mounting flange. An inner ring is fit onto the cylindrical portion. An outer member is arranged around the inner member. Double row rolling elements are freely rollably contained between the inner and outer members. The inner ring is secured in an axial direction relative to the wheel hub by a caulked portion. The caulked portion is formed by radially outwardly deforming the end of the portion of the wheel hub. A chamfer is formed on an outer circumferential surface of a back side of the inner ring. The chamfer is formed as a cut surface machined after heat treatment of the inner ring.

### CROSS-REFERENCE TO RELATED APPLICATIONS

This application is a National Stage of International Application No. PCT/JP2004/015843, filed Oct. 26, 2004, which claims priority to Japanese Patent Application No. 2003-375104, filed Nov. 5, 2003. The disclosures of the above applications are incorporated herein by reference.

### FIELD

The present disclosure relates to a bearing apparatus for a wheel of a vehicle for rotatably supporting a wheel of the vehicle relative to a suspension system, and more particularly, to a bearing apparatus for a wheel of a vehicle intended to improve the durability of an inner ring fit onto a wheel hub and a method for manufacturing the bearing apparatus.

### BACKGROUND

There are two types of bearing apparatus for a wheel of a vehicle. One for a driving wheel and one for a driven wheel. Improvements have been made to reduce manufacturing cost and to reduce the size and weight of the bearing apparatus in order to improve fuel consumption. One representative example of such a bearing apparatus of the prior art, which is a so-called third generation type, is shown in FIG. 6.

The bearing apparatus of the wheel of the vehicle of FIG. 6 has a wheel hub 51, an inner ring 52, an outer ring 53, and double row rolling elements 54, 54. The wheel hub 51 has an integrally formed wheel mounting flange 55 to mount a wheel (not shown) at one end. An inner raceway surface 51a is formed on the outer circumferential surface of the wheel hub 51. A cylindrical portion 51b axially extends from the inner raceway surface 51a. Hub bolts 56, to secure the wheel on the flange 55, are equidistantly arranged along the periphery of the flange 55. The inner ring 52 is press-fit onto the cylindrical portion 51b of the wheel hub 51. The inner ring 52 includes, on its outer circumferential surface, an inner raceway surface 52a. The inner ring 51 is prevented from axially slipping off from the cylindrical portion 51b of the wheel hub 51 by a caulked portion 51c. The caulked portion is formed by radially outwardly deforming the end of the cylindrical portion 51b of the wheel hub 51.

The outer ring 53 has an integrally formed body mounting flange 53b. Double row outer raceway surfaces 53a, 53a are formed on the inner circumferential surface. The double row rolling elements 54 are freely rollably contained between the double row outer raceway surface 53a, 53a and the inner raceway surfaces 51a, 52a, which are arranged opposite to them.

The wheel hub 51 is formed by carbon steel including carbon of 0.40˜0.80% by weight and is hardened by high frequency induction hardening over a surface region (shown by cross-hatching) from a base of the wheel mounting flange 55 to the cylindrical portion 51b. The caulked portion 51c remains as a non-hardened portion after forging. On the other hand, the inner ring 52 is made of high carbon chrome bearing steel such as SUJ 2 and is hardened to its core by dip quenching.

Thus, it is possible to realize a bearing apparatus for a wheel of a vehicle with a low manufacturing cost and which has sufficient durability to prevent the generation of cracks in the caulked portion 51c. Also, it is possible to prevent the diameter of the inner ring 52, secured by the caulked portion 51c, from being deformed to an extent which causes practical problems. In addition, it is possible to prevent the generation of damages in the inner ring 52, such as cracks, during its caulking operation, to keep the preload at its proper value, and also to reduce the manufacturing cost by reducing the number of parts and working steps (see Japanese Laid-open Patent Publication No. 129703/1999).

In such a bearing apparatus for a wheel of a vehicle of the prior art, it is possible to prevent a force from being applied to the inner ring 52 by the caulking operation, however, the force causes such a large deformation of the diameter of the inner ring 52 that it influences the durability, pre-load or rolling fatigue life etc. However, when plastically deforming the end of the cylindrical portion 51b to form the caulked portion 51c, a region near the caulked portion 51c is also plastically deformed. Thus, the inner diameter of the inner ring 52 is radially outward expanded which generates a hoop stress within the inner ring 52.

The inner ring 52 is usually finished by grinding the inner raceway surface 52a; an inner circumferential surface of a inner ring fitted on the cylindrical portion 51b of the wheel hub 51; an end face of the front side of the inner ring contacting a shoulder 51d of the wheel hub 51; an end face of the back side and the outer circumferential surface on which a seal is fitted. On the contrary, a chamfered outer circumferential surface 57 of the back side remains in a turned finished condition before heat treatment. This chamfered outer circumferential surface 57 is intended to prevent the generation of burrs due to gouges during the working process. Also, it is to eliminate a sharp and dangerous edge. However, since its surface hardness is low before heat treatment, it is impossible to avoid the burrs or gouges during the working process.

If there are burrs or gouges on the surface of the chamfered outer circumferential surface 57, a stress concentration will be promoted by the hoop stress caused in the inner ring 52. Thus, the durability will be substantially reduced by cracks which are caused in the inner ring 52 based on the burrs or gouges.

### SUMMARY

It is therefore an object of the present disclosure to provide a bearing apparatus for a wheel of a vehicle which is light weight, compact, has advantageous durability and reliability and a method for manufacturing the bearing apparatus.

In order to achieve the above, a bearing apparatus for a wheel of a vehicle comprises an inner member including a wheel hub with an integrally formed wheel mounting flange at one end. A cylindrical portion axially extends from the wheel mounting flange. An inner ring is fitted onto the cylindrical portion. An outer member is arranged around the inner member. Double row rolling elements are freely rollably contained between the inner and outer members. The inner ring is secured in an axial direction relative to the wheel hub by a caulked portion. The caulked portion is formed by radially outwardly deforming the end of the cylindrical portion of the wheel hub. A chamfered outer circumferential surface on the back side of the inner ring is formed as a cut surface machined after heat treatment.

Since the outer chamfered surface of the back side of the inner ring is formed as a cut surface machined after its heat treatment, it is possible to eliminate burrs or gouges on the chamfered circumferential surface of the back side. Accordingly, it is possible to uniformly distribute the stress concentration which would otherwise be caused by the hoop stress caused in the inner ring during the caulking operation due to gouges on the chamfered surface and to prevent the generation of cracks in the inner wheel. Thus, it is possible to provide a bearing apparatus for a wheel of a vehicle which is light weight, compact, and has advantageous durability and reliability.

The wheel hub is directly formed on its outer circumferential surface with an inner raceway surface. The outer circumferential region from the base of the wheel mounting flange to the cylindrical portion through the inner raceway surface is hardened by high frequency induction hardening. It has a surface hardness of 54˜64 HRC. The caulked portion remains as a non-quenched portion with a surface hardness of less than 24 HRC after its forging. The hoop stress generated within the inner ring by plastic deformation of the end of the cylindrical portion is limited to less than 300 MPa. Thus, it is possible to improve the strength and durability of the wheel hub and to prevent the generation of cracks in the caulked portion. In addition, it is possible to prevent excessive deformation of the diameter of the inner ring which would cause practical problems in the inner ring. Also, it is possible to reduce the ability of the generation of damage by the hoop stress caused by the caulking operation and to maintain the preload of the inner ring at a proper value. Furthermore, it is possible to reduce the manufacturing cost with the reduction of the number of parts, working and assembling steps.

A method for manufacturing a bearing apparatus for a wheel of a vehicle comprises providing an inner member including a wheel hub with an integrally formed wheel mounting flange at one end and a cylindrical portion axially extending from the wheel mounting flange. An inner ring is fitted onto the cylindrical portion. An outer member is arranged around the inner member. Double row rolling elements are freely rollably contained between the inner and outer members. The inner ring is secured in an axial direction relative to the wheel hub by a caulked portion. The caulked portion is formed by radially outwardly deforming the end of the cylindrical portion of the wheel hub. A chamfered outer circumferential surface of the back side of the inner ring is re-cut after it is heat treated. Thus, it is possible to uniformly distribute the stress concentration which would otherwise be caused by the hoop stress caused in the inner ring during the caulking operation due to gouges on the chamfered surface. Also, it is possible to prevent the generation of cracks in the inner ring. Thus, it is possible to improve the strength and durability of the inner ring.

Since the chamfered outer circumferential surface of the back side of the inner ring is re-cut by a cutting tool of hardened steel after it is heat treated, it is possible to carry out highly accurate machining of the chamfered portion without the influence of deformation due to the heat treatment.

Since the chamfered outer circumferential surface of the back side of the inner ring is re-cut by a grinding stone at least simultaneously with an outer circumferential surface of a larger diameter end of the inner ring, it is possible to carry out highly accurate machining of the chamfered portion without the influence of deformation due to the heat treatment. In addition, since the chamfered portion can be smoothly finished, it is possible to reduce stress concentration.

Since the chamfered outer circumferential surface of the back side of the inner ring is re-cut by a grinding stone at least simultaneously with a backside end face of the front side and an inner raceway surface of the inner ring, it is possible to improve the accuracy of machining, to reduce working steps and to realize a lower manufacturing cost.

A bearing apparatus for a wheel of a vehicle comprises an inner member which includes a wheel hub with an integrally formed wheel mounting flange at one end and a cylindrical portion axially extending from the wheel mounting flange. An inner ring is fitted on the cylindrical portion. An outer member is arranged around the inner member. Double row rolling elements are freely rollably contained between the inner and outer members. The inner ring is secured in an axial direction relative to the wheel hub by a caulked portion. The caulked portion is formed by radially outwardly deforming the end of the cylindrical portion of the wheel hub. A chamfered outer circumferential surface of the back side of the inner ring is formed as a cut surface machined after it is heat treated. Thus, it is possible to eliminate burrs or gouges on the chamfered circumferential surface of the back side. Accordingly, it is possible to uniformly distribute the stress concentration which would otherwise be caused by the hoop stress caused in the inner ring during the caulking operation due to gouges on the chamfered surface. Also, it is possible to prevent the generation of cracks in the inner wheel. Thus, it is possible to provide a bearing apparatus for a wheel of a vehicle which is light weight, compact and has advantageous durability and reliability.

A method for manufacturing a bearing apparatus for a wheel of a vehicle comprises providing a bearing apparatus with the following. An inner member which includes a wheel hub with an integrally formed wheel mounting flange at one end and a cylindrical portion axially extending from the wheel mounting flange. An inner ring is fitted onto the cylindrical portion. An outer member is arranged around the inner member. Double row rolling elements are freely rollably contained between the inner and outer members. The inner ring is secured in an axial direction relative to the wheel hub by a caulked portion. The caulked portion is formed by radially outwardly deforming the end of the cylindrical portion of the wheel hub. The next step includes recutting a chamfered outer circumferential surface of the back side of the inner ring after it is heat treated. Thus, it is possible to uniformly distribute the stress concentration which would otherwise be caused by the hoop stress caused in the inner ring during the caulking operation due to gouges on the chamfered surface. Also, it is possible to prevent the generation of cracks in the inner ring. Thus, it is possible to improve the strength and durability of the inner ring.

A bearing apparatus for a wheel of a vehicle comprises an inner member which includes a wheel hub with an integrally formed wheel mounting flange at one end and a cylindrical portion axially extending from the wheel mounting flange. An inner ring is fitted on the cylindrical portion. An outer member is arranged around the inner member. Double row rolling elements are freely rollably contained between the inner and outer members. The inner ring is secured in an axial direction relative to the wheel hub by a caulked portion. The caulked portion is formed by radially outwardly deforming the end of the cylindrical portion of the wheel hub. A chamfered outer circumferential surface of the back side of the inner ring is formed as a cut surface machined after it is heat treated.

Further areas of applicability will become apparent from the description provided herein. It should be understood that the description and specific examples are intended for purposes of illustration only and are not intended to limit the scope of the present disclosure.

### DRAWINGS

Additional advantages and features of the present disclosure will become apparent from the subsequent description and the appended claims, taken in conjunction with the accompanying drawings, wherein:

FIG. 1 is a longitudinal section view of a first embodiment of a wheel bearing apparatus.

FIG. 2 is an enlarged partial view of FIG. 1.

FIG. 3 is an explanatory cross-section view showing a method for re-cutting a chamfered outer circumferential surface.

FIG. 4 is another explanatory cross-section view showing the other re-cutting.

FIG. 5 is a longitudinal section view showing a second embodiment of a wheel bearing apparatus.

FIG. 6 a longitudinal section view of a wheel bearing apparatus for a wheel of a vehicle of the prior art.

### DETAILED DESCRIPTION

The following description is merely exemplary in nature and is not intended to limit the present disclosure, application, or uses.

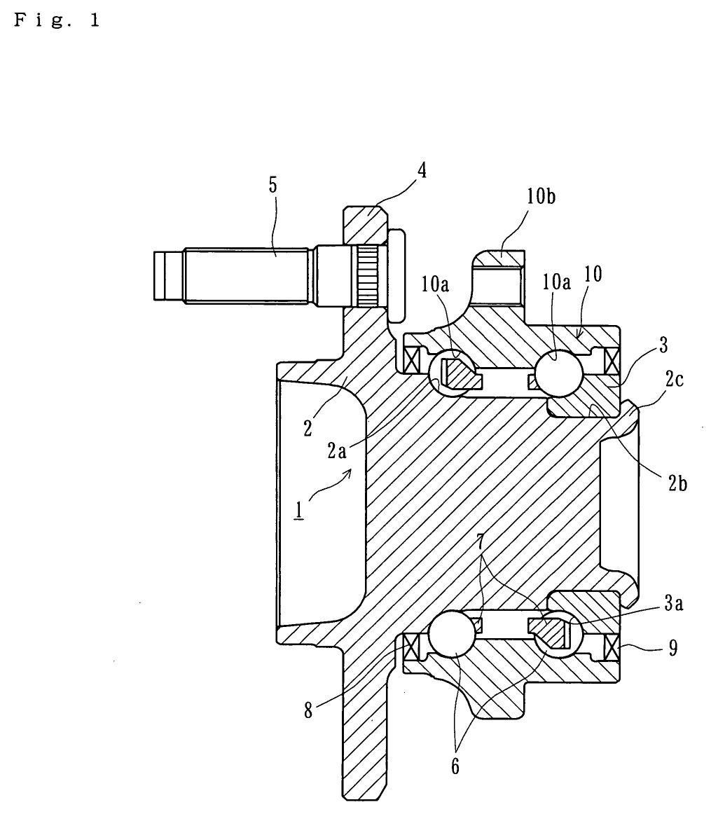

FIG. 1 shows a first embodiment of a bearing apparatus for a wheel of a vehicle. FIG. 2 is an enlarged partial view of FIG. 1. In the description below, the term “outboard side” of the apparatus denotes a side which is positioned outside of the vehicle body. The term “inboard side” of the apparatus denotes a side which is positioned inside of the body when the bearing apparatus is mounted on the vehicle body.

The illustrated bearing apparatus for a wheel of a vehicle has an inner member 1, an outer member 10 and double row rolling elements (balls) 6, 6 freely rollably retained between the inner and outer members 1, 10. The inner member 1 includes a wheel hub 2 and an inner ring 3 press-fit onto the wheel hub 2. The wheel hub 2 is integrally formed with a wheel mounting flange 4 to mount a wheel (not shown) on its outer peripheral surface at the end of the outboard side. Hub bolts 5, to secure the wheel on the flange 4, are equidistantly arranged along the periphery of the flange 4. The wheel hub 2 is also formed with one inner raceway surface on its outer circumferential surface. A cylindrical portion 2b axially extends from the inner raceway surface 2a on the wheel hub 2. The inner ring 3 is fit onto the cylindrical portion 2b. The inner ring 3 includes the other inner raceway surface 3a on its outer circumferential surface. The inner ring 3 is secured in an axial direction relative to the wheel hub 2 by a caulked portion 2c. The caulked portion 2c is formed by radially outwardly deforming the end of the cylindrical portion 2b of the wheel hub 2. According to this embodiment, since it is unnecessary to control the amount of pre-load by using a fastening nut as in the prior art, it possible to provide a self-retaining structure which can keep the proper pre-load of the bearing for a long term.

The outer member 10 is integrally formed with a body mounting flange 10b on its outer circumferential surface. The outer member is also formed with double row outer raceway surfaces 10a, 10a on its inner circumferential surface. Double row rolling elements 6, 6 are freely rollably held by cages 7, 7 between the outer and inner raceway surfaces 10a, 10a; 2a, 3a. Seals 8, 9 are arranged at the ends of the outer member 10. The seals 8, 9 prevent leakage of lubricating grease contained within the bearing as well as the ingress of rain water or dusts from the outside.

Although the illustrated bearing apparatus is a so-called third generation type where the inner raceway surface 2a is directly formed on the outer circumferential surface of the wheel hub 2, the present disclosure is not limited to only this type and can be applied to a first or second generation type where one pair of inner rings are press-fit onto the cylindrical portion of the wheel hub. In addition, although the illustrated bearing apparatus uses double row angular ball bearing, it is possible to use other bearing, such as a double row tapered roller bearing using tapered rollers as the rolling elements.

The wheel hub 2 is made of medium carbon steel which includes carbon of 0.40˜0.80% by weight such as S53C. It is hardened to a surface hardness of 54˜64 HRC by high frequency induction hardening at the inner raceway surface 2a of the outboard side, a seal land portion which contacts the seal 8, and the axially extending cylindrical portion 2b. The caulked portion 2c remains as a non-quenched portion with a surface hardness of less than 24 HRC after it is forged. The inner ring 3 is made of high carbon chrome bearing steel, such as SUJ2, and is hardened to its core by dip quenching to have a surface hardness of 54˜64 HRC. The thickness of the inner ring 3 and the caulked portion 2c as well as the caulking load are properly set so that the hoop stress caused within the inner ring 3 is limited to less than 300 MPa.

Accordingly, it is possible to improve the strength and durability of the wheel hub 2 and to prevent the generation of cracks in the caulked portion 2c. In addition, it is possible to prevent excessive deformation of the diameter of the inner ring 3 which would cause a practical problem in the inner ring 3. It is also possible to reduce the ability of the generation of damage by the hoop stress caused by the caulking operation. Further, it is possible to maintain the pre-load of the inner ring 3 at a proper value. Furthermore, it is possible to reduce the manufacturing cost with the reduction of the number of parts, and working and assembling steps.

The outer member 10 is made of medium carbon steel which includes carbon of 0.40˜0.80% by weight, such as S53C. Its double row outer raceway surfaces 10a, 10a and inner circumferential surface of the outer member 10 which contact the seals 8, 9 are hardened by high frequency induction quenching to have a surface hardness of 54˜64 HRC.

In this embodiment, the chamfered outer circumferential surface 11 of the back side of the inner ring 3 is formed by a cut surface of hardened steel machined after it is heat treated as shown in FIG. 2. That is, the chamfered surface and other portion of the inner ring 3 are cut by turning and then its predetermined portion is ground after heat treatment, but only the chamfered outer circumferential surface of the back side is re-cut before the grinding process. The re-cutting process can be carried out after the grinding process, however, it is preferable to carry out the re-cutting process before the grinding process since gouges are sometimes caused on the inner raceway surface 3a during the cutting process of the chamfered portion 11.

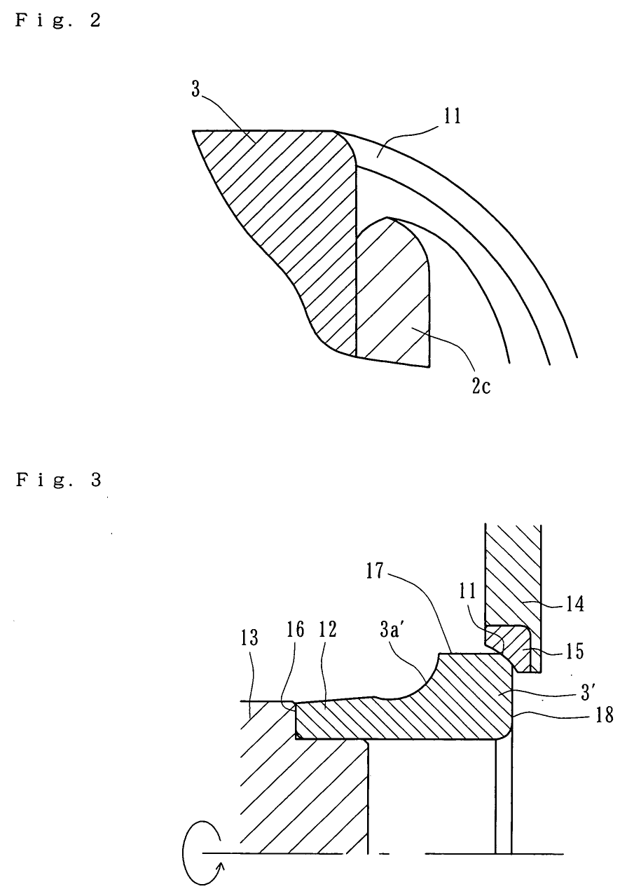

FIG. 3 is an explanatory view showing such a re-cutting method. The reference working surface of the heat treated inner ring 3′ is set by abutting the end face 16 of the front side. Next, the chamfered surface 11 of the back side is cut, by turning using a bit 14. The cutting bit 14 may include a cemented carbide chip 15 formed to have a desired configuration and dimension and it is bonded to the bit 14. The chamfered surface may also be machined with use of a NC lathe. The feeding amount of bite for machining the chamfered surface 11 is set within about 1˜3 mm both in axial and radial directions.

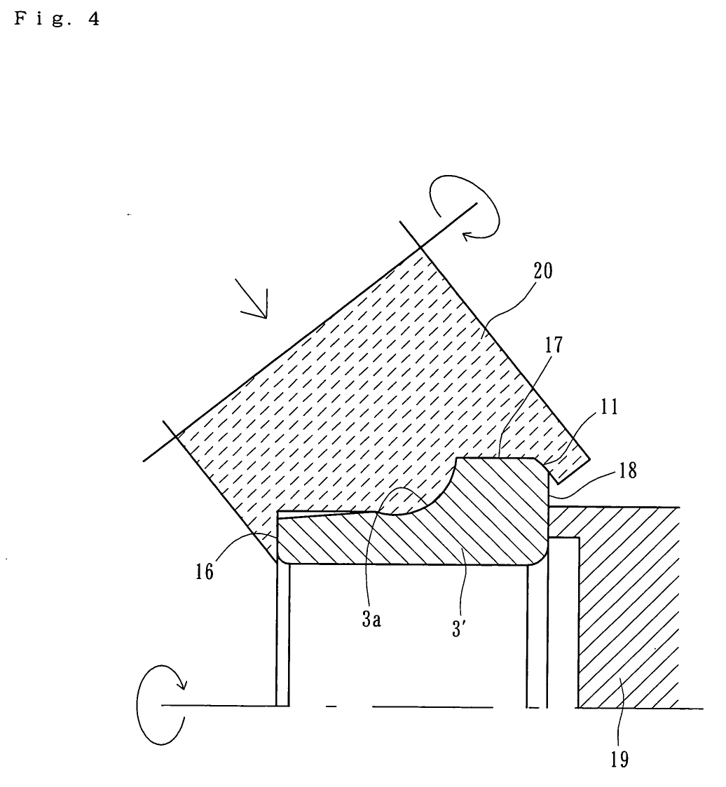

In addition to this method, there is a method for simultaneous grinding the chamfered portion 11 during grinding of the inner raceway surface 3a etc. For example as shown in FIG. 4, the reference working surface is set by abutting the end face 18 of the back side of the heat treated inner ring 3′ to a backing plate 19 of a grinding machine. The end face 16 of the front side, the inner raceway surface 3a, the outer circumferential surface 17 of a larger diameter end and the chamfered portion 11 are simultaneously ground by a single grinding stone.

More particularly, each portion of the inner ring 3′ is ground by plunge cutting with the end face 18 of the back side by magnetic attraction and then rotating the grinding stone 20 in the same rotational direction as the inner ring 3′ and feeding it at a predetermined inclined direction. This makes it possible to reduce the number of working steps and to assure the ground surfaces of having high accuracy since desirable relative circumferential speed can be obtained between each working surface and the grinding stone 20. In addition, it is possible to reduce the stress concentration at the edge portion between the circumferential surface 17 and the chamfered portion 11 since they are connected via a smooth rounded corner without any edge therebetween.

According to this embodiment, since the chamfered portion 11 of the back side of the inner ring 3′ is re-cut by the cutting bit 14 or the grinding stone 20, after it is heat treated, it is possible to eliminate burrs or gouges caused on the chamfered surface in prior working steps. Accordingly, the stress concentration which would be caused by the gouges on the chamfered surface 11 can be distributed or reduced and thus the generation of cracks on the inner ring 3 is prevented to improve the durability of the inner ring 3.

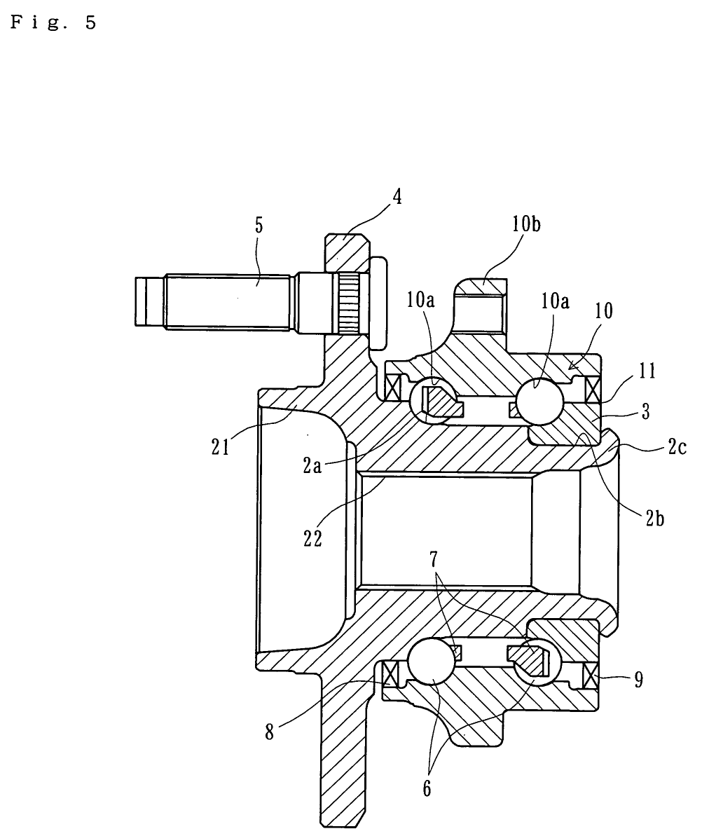

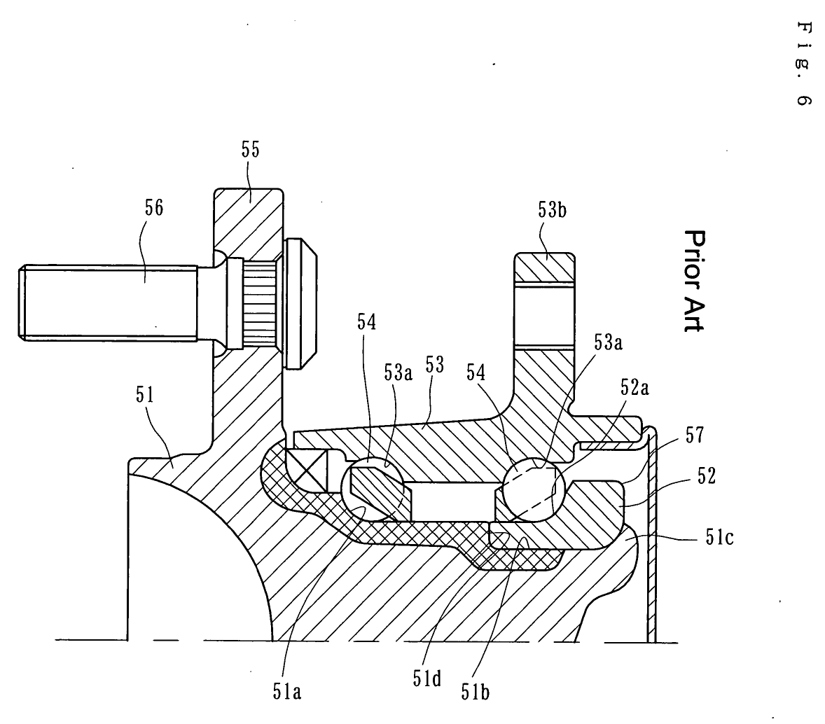

FIG. 5 is a longitudinal section view of a second embodiment of the bearing apparatus. Same reference numerals are used to designate the same parts having the same functions used in the first embodiment.

The wheel hub 21 is integrally formed with a wheel mounting flange 4 to mount a wheel (not shown) on its outer peripheral surface at the end of the outboard side. The wheel hub 21 is formed with one inner raceway surface 2a on its outer circumferential surface. A serration (spline) 22 is formed on its inner circumferential surface. The serration (spline) 22 receives an outer joint member of a constant velocity universal joint (not shown). The wheel hub 21 has a cylindrical portion 2b axially extending from the inner raceway surface 2a. The inner ring 3 is secured in an axial direction relative to the wheel hub 21 by a caulked portion 2c. The caulked portion is formed by radially outwardly deforming the end of the cylindrical portion 2b of the wheel hub 21.

Similarly to the previously described first embodiment, since the chamfered outer circumferential portion 11 of the back side of the inner ring 3 is re-cut after heat treatment, the burrs or gouges caused on the chamfered surface 11 during previous working steps can be eliminated. Accordingly, it is possible to uniformly distribute the stress concentration which would be otherwise caused by the hoop stress caused in the inner ring during the caulking operation due to gouges on the chamfered surface. Also, it is possible to prevent the generation of cracks in the inner wheel. Thus, it is possible to provide a bearing apparatus for a wheel of a vehicle which has advantageous durability and reliability.

The bearing apparatus for a wheel of a vehicle can be applied to those having self-retaining structure of the first, second and third generation types where the inner ring is press-fit onto the cylindrical portion of the wheel hub and firmly secured by caulking the end of the cylindrical portion.

The present disclosure has been described with reference to the preferred embodiments. Obviously, modifications and alternations will occur to those of ordinary skill in the art upon reading and understanding the preceding detailed description. It is intended that the present disclosure be construed to include all such alternations and modifications insofar as they come within the scope of the appended claims or their equivalents.

1-6. (canceled)

7. A bearing apparatus for a wheel of a vehicle comprising:
an inner member including a wheel hub having an integrally formed wheel mounting flange at one end and a cylindrical portion axially extending from the wheel mounting flange, an inner ring fitted on the cylindrical portion;
an outer member arranged around the inner member;
double row rolling elements freely rollably contained between the inner and outer members;
the inner ring being secured in an axial direction relative to the wheel hub by a caulked portion, said caulked portion formed by radially outwardly deforming the end of the cylindrical portion of the wheel hub; and
a chamfered outer circumferential surface of a back side of the inner ring is formed as a cut surface machined after heat treatment of the inner ring.

8. The bearing apparatus for a wheel of a vehicle according to claim 7 wherein the wheel hub is formed with an inner raceway surface on its outer circumferential surface and said wheel hub outer circumferential region from a base of the wheel mounting flange to the cylindrical portion through the inner raceway surface is hardened by high frequency induction hardening to have a surface hardness of 54˜64 HRC, said caulked portion remains as a non-quenched portion having a surface hardness less than 24 HRC after forging, and hoop stress generated within the inner ring by plastic deformation of the end of the cylindrical portion is limited to less than 300 MPa.

9. A method for manufacturing a bearing apparatus for a wheel of a vehicle comprising:
providing an inner member including a wheel hub having an integrally formed wheel mounting flange at one end and a cylindrical portion axially extending from the wheel mounting flange, an inner ring fitted on the cylindrical portion; an outer member arranged around the inner member, and double row rolling elements freely rollably contained between the inner and outer members;
securing the inner ring in an axial direction relative to the wheel hub;
radially outwardly deforming the end of the cylindrical portion of the wheel hub forming a caulked portion;
recutting a chamfered outer circumferential surface of a back side of the inner ring after heat treatment of said inner ring.

10. The method for manufacturing a bearing apparatus for a wheel of a vehicle according to claim 9 wherein said recutting of the chamfered outer circumferential surface of the back side of the inner ring is re-cut by a hardened steel cutting tool after said heat treatment.

11. The method for manufacturing a bearing apparatus for a wheel of a vehicle according to claim 9 wherein said recutting of the chamfered outer circumferential surface of the back of the inner ring is re-cut by a grinding stone and at least simultaneously cutting an outer circumferential surface of a larger diameter end of the inner ring.

12. The new method for manufacturing a bearing apparatus for a wheel of a vehicle according to claim 11 wherein said recutting of the chamfered outer circumferential surface of the back side of the inner ring is re-cut by a grinding stone and at least simultaneously cutting a backside end face of a front side of the inner ring and an inner raceway surface of the inner ring.
